(19) United States
(12) Patent Application Publication
(10) Pub. No.: US 2014/0361088 A1
(43) Pub. Date: Dec. 11, 2014

(54) ELECTRONIC IDENTIFYING APPARATUS

(71) Applicants: HONG FU JIN PRECISION INDUSTRY (ShenZhen) CO., LTD LTD., Shenzhen (CN); HON HAI PRECISION INDUSTRY CO., LTD., New Taipei (TW)

(72) Inventors: ZONG-YUAN SUN, New Taipei (TW); DA-HUA XIAO, Shenzhen (CN)

(21) Appl. No.: 14/302,389

(22) Filed: Jun. 11, 2014

(30) Foreign Application Priority Data
Jun. 11, 2013 (CN) 2013203342552

(51) Int. Cl. G06K 19/077; G06K 19/073

(52) U.S. Cl. CPC G06K 19/07707; G06K 19/073
USPC 235/492

(57) ABSTRACT

An electronic identifying apparatus includes a control terminal for inputting article information and an radio frequency (RF) tag for displaying the article information. The RF tag includes a signal receiving module, a first signal processing module electronically connected to the signal receiving module, and a first display module electrically connected the first signal processing module. The signal receiving module receives signals which comprise the article information from the control terminal. The first signal processing module receives the article information from the signal receiving module. The first display module displays the article information.

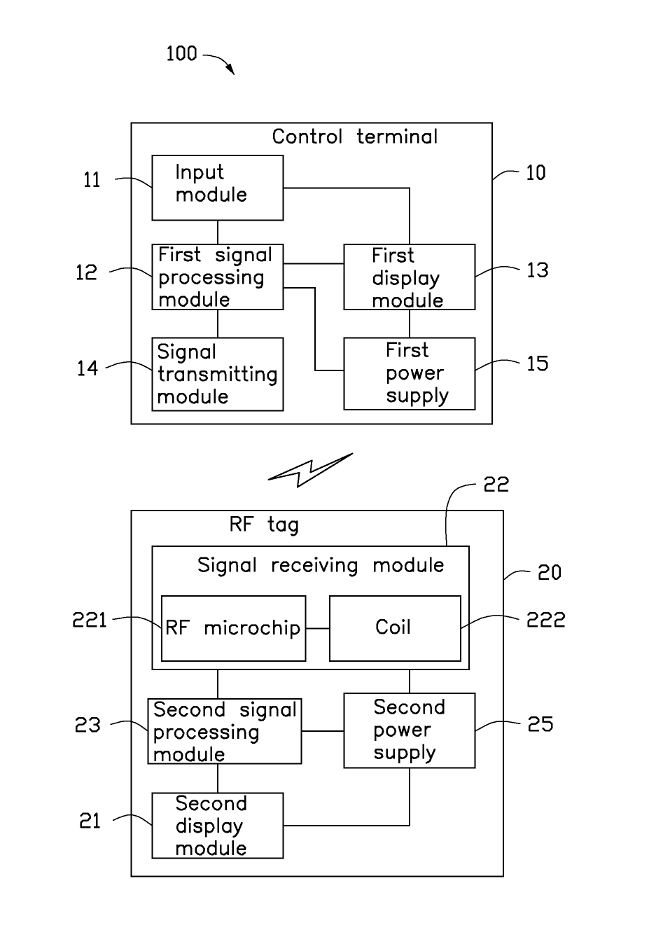

### FILED

The disclosure generally relates to electronic identifying apparatuses and particularly to an electronic identifying apparatus for easily and accurately identifying article information.

### BACKGROUND

During a manufacture process of electronic products, the electronic products are commonly received in packaging boxes (e.g. a tray or a case) and transmitted to each work station for processing and assembly. Product information such as a product model, a product number, or the like is recorded in paper identifiers (e.g. barcodes or tags). The identifiers are attached to the corresponding packaging boxes for easily identifying the electronic products inside the packaging boxes. However, for repeated use of the packaging boxes, the identifiers for different electronic products may be attached to the same packaging box which is tedious and can lead to a mistake in record keeping.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present embodiments.

The FIGURE is a block diagram of an embodiment of an electronic identifying apparatus.

### DETAILED DESCRIPTION

The FIGURE is a block diagram of an embodiment of an electronic identifying apparatus 100. The electronic identifying apparatus 100 can be used to identify articles (e.g. electronic products, or electronic components) during a manufacture or transmitting process and also can be used to display article information (e.g. prices of the articles in supermarket). The electronic identifying apparatus 100 includes a control terminal 10 and a radio frequency (RF) tag 20. The control terminal 10 inputs (or writes) the article information to the RF tag 20. The RF tag 20 displays the input article information.

In one exemplary embodiment, the control terminal 10 includes an input module 11, a first signal processing module 12, a first display module 13, a signal transmitting module 14, and a first power supply 15. The input module 11, the first display module 13, and the signal transmitting module 14 are electronically connected to the signal processing module 12. The first signal processing module 12 and the first display module 13 are electronically connected to the first power supply 15.

The input module 11 is configured for inputting article information and transmitting the article information to the first signal processing module 12. The first signal processing module 12 receives the article information from the input module 11. The first signal processing module 12 converts the received article information from an analog signal to a digital signal, and transmits the converted article information to the first display module 13. The first display module 13 displays the converted article information. The first signal processing module 12 also transmits the converted article information to the signal transmitting module 14. The signal transmitting module 14 transmits the received article information to the RF tag 20. The signal transmitting module 14 may be an radio frequency identification (RFID) transmitting module. The first power supply 15 provides electric power to the first signal processing module 12 and the first display module 13. In one exemplary embodiment, the first power supply 15 is a battery.

The RF tag 20 is a multiple frequency passive component. The RF tag 20 includes a second display module 21, a signal receiving module 22, a second signal processing module 23, and a second power supply 25. The second display module 21, the signal receiving module 22, the second signal processing module 23 are electronically connected to the second power supply 25. The signal receiving module 22 is electronically connected to the signal processing module 23.

The signal receiving module 22 includes an RF microchip 221 and a coil 222 connected to the RF microchip 221. The coil 222 couples with the signal transmitting module 14 so that the RF microchip 221 receives signals at different frequencies (e.g.

high frequency signals or low frequency signals) which comprise the converted article information transmitted from the signal transmitting module 14. The second signal processing module 23 receives the converted article information from the RF microchip 221 and transmits the converted article information to the second display module 21. The second display module 21 displays the article information. The second power supply 25 is a battery which provides electric power to the second display module 21, the signal receiving module 22, and the second signal processing module 23. The second display module 21 may be electronic paper.

In use, the RF tag 20 is attached to a packaging box (e.g. a transmitting case, a tray, or a storage rack) to display the article information of the articles packaged in the packaging boxes. When the articles packaged in the packaging box are changed, the article information of the articles is input into the control terminal 10 by the input module 11. The first signal processing module 12 transmits the input article information to the signal transmitting module 14. The signal transmitting module 14 transmits the article information to the RF tag 20. The signal receiving module 22 receives the article information and transmits the article information to the second signal processing module 23. The second signal processing module 23 transmits the article information to the second display module 21 to display the article information of the current articles.

Therefore, new RF tag 20 is not needed to attach to the packaging box for the changed articles. The RF tag 20 can update and display the article information of the current articles inside the packaging boxes by the control terminal 10 timely so that the article information of the current articles can be accurately displayed. The RF tag 20 and the packaging boxes can be reused which is environmentally friendly. Furthermore, the second power supply 25 set inside the RF tag 20 can solve the problem that the second display module 21 cannot display article information when an external power supply is powered off.

It is to be understood that even though numerous characteristics and advantages of the disclosure have been set forth the disclosure is illustrative only, and changes may be made in detail, including in the matters of shape, size, and arrangement of parts within the principles described. The embodiments described herein are illustrative, and should not be construed as limiting the following claims.

What is claimed is:

1. An electronic identifying apparatus, comprising:
a control terminal for inputting article information; and
an radio frequency (RF) tag for displaying the article information, the RF tag comprising:
a signal receiving module receiving signals which comprise the article information from the control terminal;
a first signal processing module electronically connected to the signal receiving module, the first signal processing module receiving the article information from the signal receiving module; and
a first display module configured to display the article information.

2. The electronic identifying apparatus of claim 1, wherein the signal receiving module comprises an RF microchip and a coil connected to the RF microchip; the coil couples with the control terminal, enabling the RF microchip to receive the signals from the control terminal.

3. The electronic identifying apparatus of claim 1, wherein the RF tag further comprises a first power supply electronically connected to the first signal processing module and the first display module, wherein the first power supply provides electric power to the first signal processing module and the first display module.

4. The electronic identifying apparatus of claim 1, wherein the control terminal comprises an input module, a second signal processing module, and a signal transmitting module; the input module is configured for inputting the article information, the second signal processing module converts the received article information from an analog signal to a digital signal, and the signal is configured to transmit module transmits the converted article information to the signal receiving module.

5. The electronic identifying apparatus of claim 4, wherein the control terminal further comprises a second power supply electrically connected to the input module, the second signal processing module, and the signal transmitting module, the second power supply providing electric power to the input module, the second signal processing module, and the signal transmitting module.

6. The electronic identifying apparatus of claim 4, wherein the control terminal further comprises a second display module electrically connected to the second signal processing module, the second display module configured to display the converted article information.

7. An radio frequency (RF) tag for displaying article information transmitted from an control terminal, the RF tag comprising:
a signal receiving module receiving signals at different frequencies which comprise the article information from the control terminal;
a first signal processing module electronically connected to the signal receiving module, the first signal processing module receiving the article information from the signal receiving module; and
a first display module configured to display the article information.

8. The RF tag of claim 7, wherein the signal receiving module comprises an RF microchip and a coil connected to the RF microchip; wherein the coil couples with the control terminal, enabling the RF microchip to receive the signals from the control terminal.

9. The RF tag of claim 7, further comprising a first power supply electronically connected to the first signal processing module and the first display module, wherein the first power supply provides electric power to the first signal processing module and the first display module.
